(19) United States
(12) Patent Application Publication
(10) Pub. No.: US 2006/0135190 A1
(43) Pub. Date: Jun. 22, 2006

(54) Dynamic remote storage system for storing software objects from pervasive devices

(76) Inventors: Francois X. Drouet, Nice (FR); Gerard Marmigere, Drap (FR); Vincent Outters, Gattieres (FR)

Correspondence Address: DILLION & YUDELL, LLP, 8911 N CAPITAL OF TEXAS HWY, SUITE 2110, AUSTIN, TX, 78759, US

(21) Appl. No.: 11/264,641

(22) Filed: Nov. 1, 2005

(30) Foreign Application Priority Data
Dec. 20, 2004 (EP) 04300921.6

(51) Int. Cl. H04B 7/00

(52) U.S. Cl. 455/514

(57) ABSTRACT

A dynamic remote storage system for storing software objects from a mobile device is disclosed. The dynamic remote storage system includes a remote storage bank server and a wireless communication network. The remote storage bank server is accessible by a user via a terminal. The wireless telecommunication network is capable of providing wireless communication between the remote storage bank server and the mobile device having an object manager. In response to a user's commands, the object manager transfers software objects between the remote storage bank server and the mobile device via the wireless telecommunication network.

### RELATED PATENT APPLICATION

The present patent application claims priority to a European Application No. EP04300921.6, filed on Dec. 20, 2004.

### BACKGROUND OF THE INVENTION

1. Technical Field

The present invention relates to storage systems in general, and in particular to remote storage systems. Still more particularly, the present invention relates to a dynamic remote storage system for storing software objects from pervasive devices.

2. Description of the Related Art

Increasingly, pervasive devices, such as mobile telephones, personal digital assistants (PDAs), etc., are demanded to store a large number of objects, such as logos, ring tones, pictures, music, video, e-books, midlet (games) and/or other electronic files. Objects can be downloaded to a pervasive device through a cable or a wireless connection such as Bluetooth or infrared.

In a mobile telephone environment, either Short Message Service (SMS) or Extended Message Service (EMS) can be used to download objects to a pervasive device. For example, a user can call a specific number, sends a SMS to a service and selects an object, and, in turn, the user will be automatically charged on his/her bill.

The Point-to-Point SMS provides a way of sending messages of limited size to and from mobile telephones, initially using Global System for Mobile communications (GSM) along with recent extensions to wire line telephones. Typically, cell transmission/reception is conducted on a signalling channel, over the air interface, as specified, for example, by GSM, IS-41, IS-54 and other standards. The provision of SMS makes use of a SMS service center (SMS-C), which acts as a store and forward center for short messages.

The Multimedia Messaging Service (MMS) technology is now available with Universal Mobile Telecommunications System (UMTS) to provide a greater bandwidth, thereby enabling the download of larger objects such as music (e.g., MP3) or video (e.g., MPEG2, MPEG4).

Most pervasive devices typically do not have enough storage space to store all the objects a user would like. If a user tries to download new objects via SMS and his/her pervasive device does not have enough storage space, the user will be informed that messages are waiting at the SMS-C. A user may be forced to remove some objects from his/her pervasive device in order to make room for new objects. Also, if the user obtains a new pervasive device, the objects in the old pervasive device cannot be easily transferred to the new pervasive device. Consequently, it would be desirable to provide a method and system to overcome those problems.

### SUMMARY OF THE INVENTION

In accordance with a preferred embodiment of the present invention, a dynamic remote storage system includes a remote storage bank server and a wireless communication network. The remote storage bank server is accessible by a user via a terminal. The wireless telecommunication network is capable of providing wireless communication between the remote storage bank server and a mobile device having an object manager. In response to a user's commands, the object manager transfers software objects between the remote storage bank server and the mobile device via the wireless telecommunication network.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a dynamic remote storage system, in accordance with a preferred embodiment of the present invention;

FIG. 2 is a block diagram of two object tables, in accordance with a preferred embodiment of the present invention;

FIG. 3 is a high-level logic flow diagram of a method for downloading an object to a dynamic remote storage system, in accordance with a preferred embodiment of the present invention;

FIG. 4 is a high-level logic flow diagram of a method for executing an object within a dynamic remote storage system, in accordance with a preferred embodiment of the present invention; and

FIG. 5 is a high-level logic flow diagram of a method for managing an object within a dynamic remote storage system, in accordance with a preferred embodiment of the present invention.

### DETAILED DESCRIPTION OF A PREFERRED EMBODIMENT

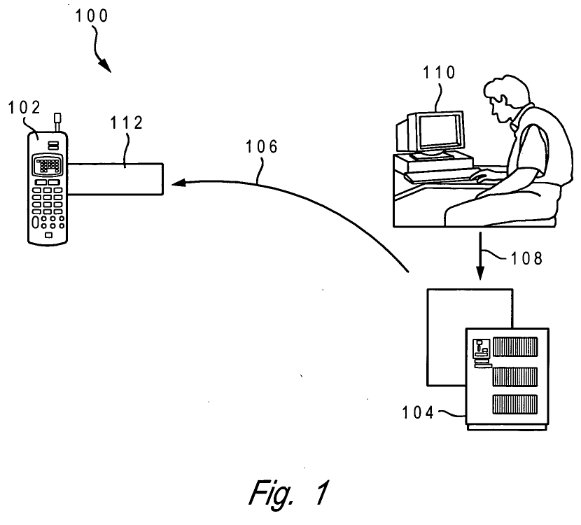

Referring now to the drawings and in particular to FIG. 1, there is depicted a diagram of a dynamic remote storage system, in accordance with a preferred embodiment of the present invention. As shown, a dynamic remote storage system 100 includes a mobile device 102, a remote storage bank server (RSBS) 104, a wireless communication network 106, a communication network 108 and a terminal 110. Furthermore, mobile device 102 includes an object manager or extension bank client (EBC) 112 and a local storage means (not shown).

EBC 112 dynamically manages software objects associated with mobile device 102. EBC 112 may upload some objects from mobile device 102 to RSBS 104 for remote storage, and EBC 112 may request those objects from RSBS 104 at a later stage if those objects are required by mobile device 102.

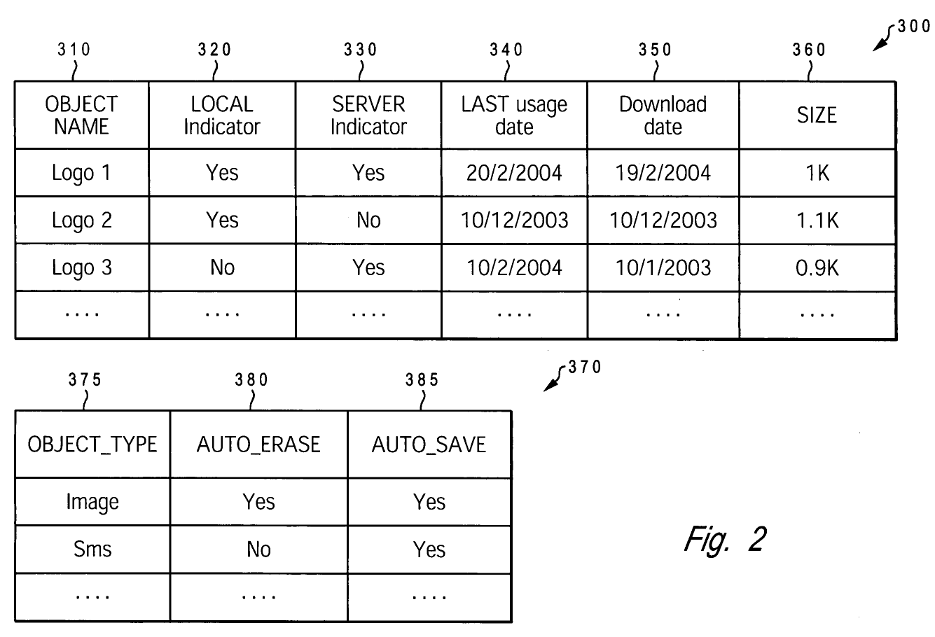

With reference now to FIG. 2, there is depicted a block diagram of two object tables within EBC 112, in accordance with a preferred embodiment of the present invention. As shown, EBC 112 includes an object table 300 and an object type table 370. Object table 300 is used to maintain information related to objects stored on a local storage means within RSBS 104. In this example, object table 300 contains an object name field 310, a local indicator field 320, a server indicator field 330, a last usage date field 340, a download date field 350 and a size field 360. When an object is first downloaded, information such as object name, download date and size are automatically entered into corresponding fields within object table 300. The remaining fields are updated according to where the object is stored. For example, local indicator field 320 is used to indicate storage in the local storage means of mobile device 102, and server indicator field 330 is used to indicate storage in RSBS 104, and last usage date field is used to indicate when the object was last used.

Object type table 370 includes an object type field 375, an auto-erase field 380 and an auto-save field 390. Object type field 375 may associate objects according to objects file extension or by genre of object, such as pictures or movies. A user of mobile device 102 can alter object type table 370 to determine how EBC 112 interacts with particular object types. For example, logos and music could be dynamically managed while games would need confirmation from the user before any action, such as “copy from device to server,” “delete on device,” “copy from remote server to device,” would be actually taken.

As EBC 112 maintains information about remotely stored objects as well as locally stored objects, the user has access to and the ability to delete objects on mobile device 102 or on RSBS 104 through wireless communication means 106 established between EBC 112 and RSBS 104. At any point in time, the user can have a clear view about which objects are currently on mobile device 102 and which objects are on RSBS 104.

In order to use dynamic remote storage system 100 according to a preferred embodiment of the present invention, a user has to be authenticated on RSBS 104. A user can be authenticated through a user identification (ID) number or string. The user ID is normally issued when a user subscribes to dynamic remote storage system 100, for example, by using terminal 110 to connect to RSBS 104 via communication network 108.

At time of subscription, the user defines at least one mobile device to be utilized in dynamic remote storage system 100. Each mobile device that is used in dynamic remote storage system 100 is identified by RSBS 104 using a Mobile Station Integrated Services Digital Network (MSISDN) value. Mobile devices may be added or deleted from the subscription at any time by the user. The user can also define at subscription time, or at a later date, the types of object which should be dynamically managed. The information entered at the time of subscription is use to create or update object type table 370.

Authentication is to be carried out at connection time. Different authentication schemes are possible, depending on the type of network that is being used. For example, on a GSM network, EBC 112 may send the user ID to RSBS 104, hashed with the MSISDN of mobile device 102. RSBS 104 receives the communication and extracts the MSISDN and user ID before checking the user ID versus the authorized list. EBC 112 is then authorized to interact with RSBS 104 for a given period of time. For security reasons, a time-out is defined after which a new authentication is required before further exchanges.

When a new mobile device, identified by its MSISDN, needs to be added under subscription of a given user ID, it will be added to the list of mobile devices being subscribed. When a mobile device, identified by its MSISDN, requires removal from the subscription of a given user ID, it will be removed from the list of mobile devices being subscribed in RSBS 104.

I. Download Flow

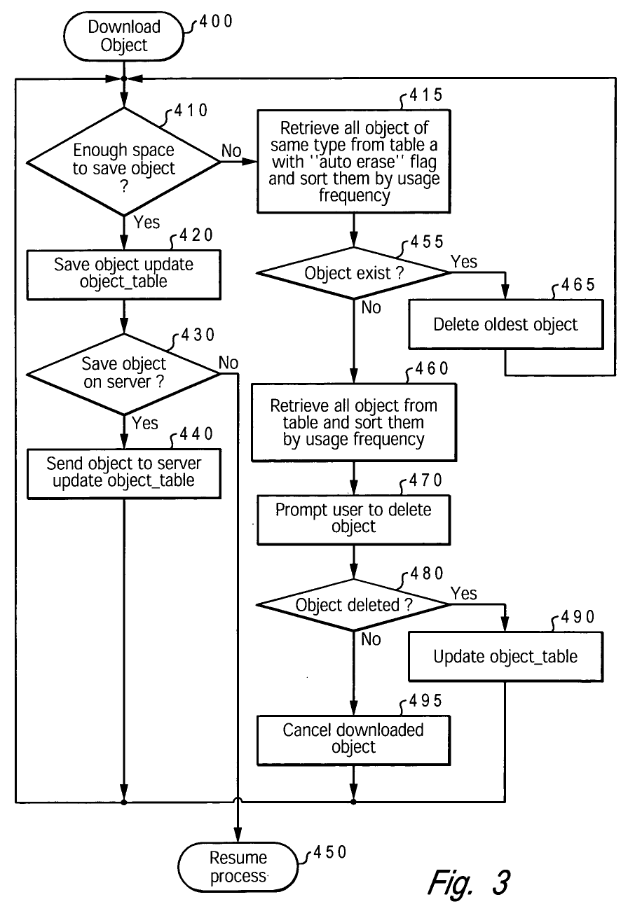

Referring now to FIG. 3, there is depicted a high-level logic flow diagram of a method for downloading an object to a dynamic remote storage system, in accordance with a preferred embodiment of the present invention. Before a user downloads a new object, as shown in block 400, a determination is made as to whether there is enough space in the local storage means within mobile device 102 for storing the object, as depicted in block 410. If there is enough storage space within mobile device 102, the object is saved, and a table entry is created in object table 300, as shown in block 420. The following fields in object table 300 are updated:

object name field 310 is loaded with the name of the object;

local indicator field 320 is set to “yes” to indicate that the object is locally present;

server indicator field 330 is set to “no” as the object has not been saved on RSBS 104 at this time;

download date field 350 is set with the current date; and

size field 360 is set with the size of the object.

A prompt is used to ask the user to decide if the object should be saved on RSBS 104 or not, as depicted in block 430. If the object has to be saved, it is sent to RSBS 104 by a remote save module, as shown in block 440, using a communication means available on mobile device 102, such as SMS on the GSM network, GPRS or any other wired or wireless communication protocol. The remote save module also updates server indicator field 330 in object table 300 to “Yes” to indicate that the object has been saved on RSBS 104. Then, the process is resumed at block 450. Otherwise, if the answer to the prompt in block 430 is “no,” meaning that the object should not be saved on the server, and the process is resumed in block 450.

If the free space module in block 410 indicates that there is not enough space to save the object on the local storage means, an object retrieve module retrieves all objects saved on a local storage means of the same type as the object and which have flag auto erase field 380 sorted by usage frequency using last usage date field 340, as shown in block 415. A determination is made as to whether matching objects exist, as depicted in block 455. If matching objects exist, the oldest object among the retrieved objects is deleted, as shown in block 465, and the process proceeds to block 410 to verify if the new free space is enough to download the object.

If no matching objects exist, then all objects saved on the local storage means are retrieved, as shown in block 460, and sorted by usage frequency using last usage date field 340 of object table 300. A delete prompt is used to prompt the user to choose an object to be deleted in order to free some space on mobile device 102, as depicted block 480. If the user decides to delete an object, the entry corresponding to such object is deleted from object table 300, and the free space module (from block 410) is again required to check if there is enough space on mobile device 102 to save the new object. If the user decides to not delete any object, the object download is cancelled, as shown in block 495, and the process is resumed at block 450.

Alternatively, when a user receives a new object and there is not enough space on mobile device 102 to receive the new object, EBC 112 may save the object on RSBS 104. Object table 300 would then be updated on mobile device 102 to reflect the location of the new object. If the user then wants to access to the object, a fetch command is sent to RSBS 104, and the object is sent to mobile device 102.

II. Execute Flow

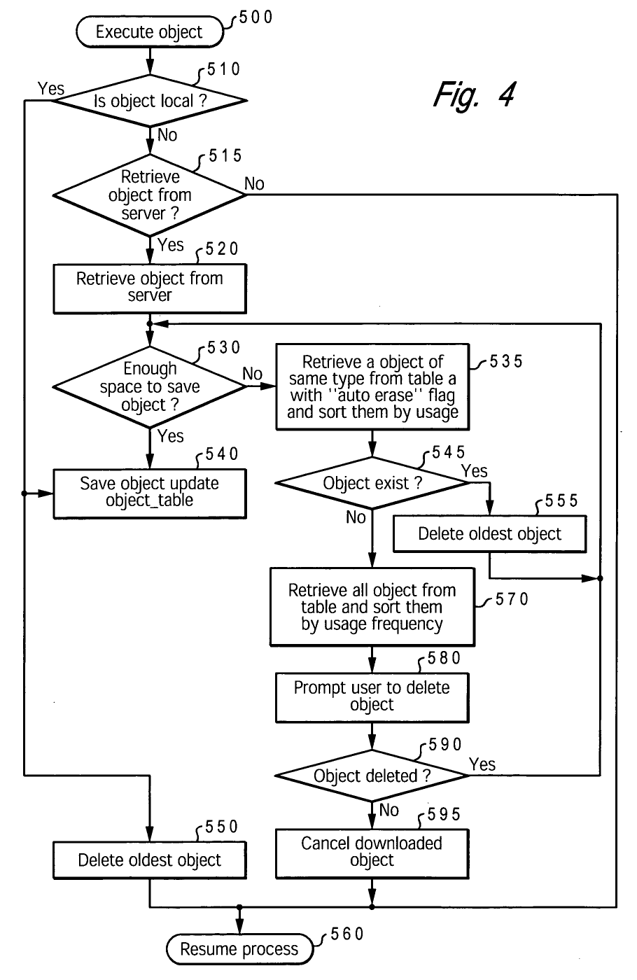

With reference now to FIG. 4, there is depicted a high-level logic flow diagram of a method for executing an object within a dynamic remote storage system, in accordance with a preferred embodiment of the present invention. When a user launches an application or tries to use an object, as shown in block 500, an object location module checks local indicator field 320 within object table 300, as depicted in block 510. If the object is found locally, the object is executed, as shown in block 550, and the process is resumed at block 560. If the object is not found locally, then a retrieve prompt is used to prompt the user to download the object from RSBS 104, as depicted in block 515. If the user decides to download the object, a fetch module retrieves the object from RSBS 104, as shown in block 520.

A determination is made as to whether or not there is enough space to save the retrieved object, as shown in block 530. If a free space module indicates that there is enough space on mobile device 102, the object is saved in object table 300, as depicted in block 540. The following fields within object table 300 are updated:
local indicator field 320 is set to “yes” to indicate that the retrieved object is saved in the local storage means;
last usage date field 340 is set with the current date; and
size field 360 is set with the size of the retrieved object.
   Then, the retrieved object is executed, as shown in block 550, and the process is resumed in block 560.

Otherwise, if the free space module indicates that there is not enough space on the local storage means, an object retrieve module retrieves all objects of same type (based on field 375) and with “AUTO ERASE” in field 380 present in the local storage means are retrieved and sorted by usage frequency, using last-usage date field 340 within object table 300, as depicted in block 535.

A determination is made as to whether or not the object exists, as shown in block 545. If the object retrieve module indicates the object exists. the oldest object among all retrieved objects is deleted, as shown in block 555, and the process proceeds to block 530 to verify if the new free space is enough to download the object. If no objects allowing “AUTO ERASE” are found by the object retrieve module, all objects saved are retrieved, as shown in block 570, and sorted by usage frequency using last-usage date field 340 of object table 300. A delete object prompt is then used to prompt the user to choose an object, or objects, to be deleted in order to free space in the local storage means on mobile device 102, as shown in block 580.

If the user decides to delete an object, the entry corresponding to the object is updated in object table 300, setting local indicator field 320 to “no” to indicate that the object is not locally present. If server_indicator field 330 is set to “no,” meaning that the object is not on the server, the entry corresponding to the object in object table 300 is deleted.

If an object is deleted, the process of checking if the required space available begins once again at the free space module, as depicted in block 530. If the user decides not to delete any object, the object download is cancelled, as shown in block 595, and the process is resumed in block 560.

III. Manage Local Object

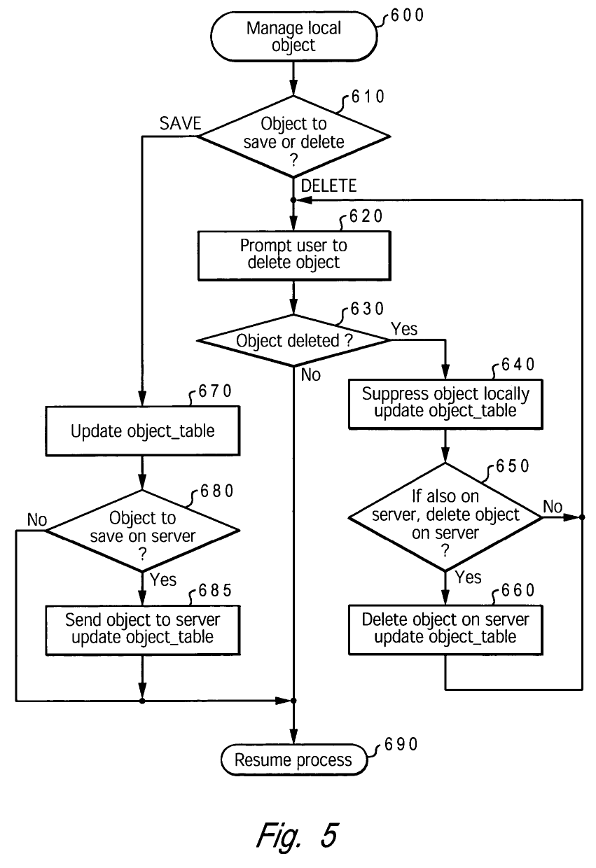

Referring now to FIG. 5, there is depicted a high-level logic flow diagram of a method for managing an object within a dynamic remote storage system, in accordance with a preferred embodiment of the present invention. A local object management function allows the user to decide if an object has to be managed by EBC 112 or if an object has to be deleted either from the local storage means or both from the local storage means and RSBS 104. When the local object management function is launched, as shown in block 600, and a object is chosen for management, the user is prompted to determine which function has to be executed, as depicted in block 610. If the requested function is “Save”, an entry in object table 300 is created, as shown in block 670, and the following fields within object table 300 are filed:

object name field 310 set with the name of the object;

local indicator field 320 is set to “yes” to indicate that the object is available on the local storage means;

server indicator field 330 is set to “no” as far as the object has not been saved yet on the rsbs 104;

download date field 350 is set with the current date; and

size field 360 is set with the size of the downloaded object.

Then, the user is prompted to decide if the object has to be saved on the RSBS 104 or not, as shown in block 680. If the object has to be saved, it is sent to RSBS 104 using a remote save module available on mobile device 102, such as SMS on the GSM network, as depicted in block 685. Server indicator field 330 of object table 300 is set to “Yes” to indicate that the object has been saved on RSBS 104. Then, the process is resumed at block 690. Otherwise, if the answer to the prompt in block 680 is “no,” the object has not to be saved on RSBS 104, then the process is resumed at block 690.

If the answer to the prompt in block 610 indicates that the requested function is “delete,” a further prompt confirms that the object is to be deleted, as shown in block 620. If the user decide to delete the object, the entry corresponding to the object is updated in object table 300, as shown in block 640, setting local Indicator field 320 to “no” to indicate that the object is not present on the local storage means. If server indicator field 330 is set to “no,” as shown in block 650, meaning that the object is no longer in the server; the entry corresponding to the object in object table 300 is deleted.

The type of network used to carry the protocol between EBC 112 and RSBS 104 could be: GSM, GPRS, Wi-Fi, UMTS, Internet Protocol based connectivity or any other suitable communication means. When a user wants to communicate with RSBS 104 they can select the type of network required according to the location and the capabilities available to mobile device 102.

As has been described, the present invention provides a dynamic remote storage system for storing objects from pervasive devices.

It is also important to note that although the present invention has been described in the context of a fully functional storage system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A dynamic remote storage system for storing software objects from a pervasive device, said system comprising:
a remote storage bank server having an object storage means, wherein said remote storage bank server is accessible by a user via a terminal; and
a wireless telecommunication network is capable of providing wireless communication between said remote storage bank server and a mobile device having an object manager and a local storage means, wherein said object manager is capable of transferring objects between said remote storage bank server and said mobile device via said wireless telecommunication network.

2. The system in claim 1, wherein said object manager includes an object table for maintaining information on software objects stored in said object storage means and/or said local storage means.

3. The system in claim 1, wherein said object manager, in response to a software object needed to be downloaded, determines how much free space in said local storage means, and stores said software object in said local storage means if there is enough free space for storing said software object.

4. The system in claim 3, wherein said object manager looks up said object table to determine which one or more local objects stored in said local storage means needs to be removed in order to provide more free space in said local storage means.

5. The system in claim 4, wherein said object manager uploads one or more software objects from said local storage means to said object storage means before downloading said software object.

6. The system in claim 5, wherein said object manager further includes an object type table for determining how said object manager manages particular object types.

7. The system in claim 6, wherein said object manager determines which software objects to be removed based on last usage date, download date and object type.
